(19) United States
(12) Patent Application Publication
(10) Pub. No.: US 2012/0284090 A1
(43) Pub. Date: Nov. 8, 2012

(54) SYSTEM AND METHOD FOR ACCUMULATION AND VERIFICATION OF TRUST FOR PARTICIPATING USERS IN A CROWD SOURCING ACTIVITY

(76) Inventors: Sergejs Marins, Toronto (CA); Grant Ritchie, Toronto (CA)

(21) Appl. No.: 13/462,368

(22) Filed: May 2, 2012

Related U.S. Application Data
(60) Provisional application No. 61/481,640, filed on May 2, 2011.

(51) Int. Cl. G06Q 10/06

(52) U.S. Cl. 705/7.39

(57) ABSTRACT

The present invention is a computer network implemented system and method for verifying that individual participants complete one or more crowd sourcing activities in a manner that is accurate and/or correct, and granting incentives to participating users based on accurate and/or correctly completed activities. The one or more crowd sourcing activities may include a plurality of tasks, each task including optionally a plurality of sub-tasks. Accurately and/or correctly completing activities may cause participant users to accumulate trust and such trust may be tangibly represented as Trust Scores, Quality Scores, and incentives allotted to participant users. The present invention is operable to accumulate and verify trust for each of the participating users. The present invention may improve quality of the crowd sourcing activity by awarding Trust Scores to participating users, and awarding Quality Scores to tasks or sub-tasks completed by the various participating users.

### FIELD OF THE INVENTION

This invention relates generally to platforms for creation or collection of information based on contribution from multiple participants in one or more crowd sourcing activities, and more specifically to a system and method for verifying trust and accumulating incentives based on that trust.

### BACKGROUND

Many activities are time intensive, and often involve multiple tasks, undertaken by a plurality of entities, whether individuals or computers (in this disclosure an “entity” or “entities” refers to individuals, computers or both). The plurality of entities may be involved in an activity for various reasons. For example, a plurality of entities may be involved in an activity due to the volume of the work involved in the activity. A plurality of entities may also be involved in an activity in order to complete the activity efficiently, so that specific tasks involved in the activity are allocated to individuals with characteristics that enable them to complete the tasks more quickly. To complete an activity efficiently a plurality of entities may be further be involved in an activity in order to complete the activity in a way that is consistent with qualitative objectives such as accuracy, consistency, compliance with specific standards, protocols or templates, interoperation with systems, or other factors.

Traditionally, the work related to such activities is completed by a group of employees or contractors, or computers controlled by such employees or contractors. However, the cost of completing activities can be reduced by leveraging essentially volunteers, or computers controlled by volunteers, and organizing the work of these volunteers or their computers through the use of Internet technologies.

Prior art systems and solutions that have attempted to leverage volunteers via the Internet are generally referred to as “crowd sourcing” solutions. “Crowd sourcing” or “crowdsourcing” is a neologistic compound of “crowd” and “outsourcing”, describing the act of taking tasks traditionally performed by an employee or contractor, and outsourcing them to a group of people or community. The outsourcing may occur through an “open call” to a large group of people (a crowd) who are asked for contributions. Participants typically do not receive monetary compensation and the environment is typically not competitive.

As an example, WIKIPEDIA™, the well known online encyclopedia, relies in part on voluntary contributions based on a crowd sourcing model. However, its accuracy is maintained by a relatively large editorial staff. Most of this editorial staff is unpaid, but their participation is motivated by social incentives. As an example, such social incentives include that being a WIKIPEDIA editor confers reputation which participants value on its own merit, and that this editorial work may provide indirect benefits, such as recognition as a subject matter expert, which in turn may assist in job searching or career advancement.

The success of WIKIPEDIA resulted in certain companies, such as Brownbook.net™ and Yellowikis™, initiating the collection of business profiles on a crowd sourced basis. These prior art solutions were not successful in securing active participation of locals to keep up with the rate of change in the location data, and also the data collected suffered from a relatively significant degree of inaccuracy.

These prior art solutions are limited at least in part by the lack of a comprehensive system or method for accumulating and verifying whether individual participants can be relied upon to correctly and/or accurately complete one or more crowd sourcing activities. Such prior art solutions potentially lead to a loss of motivation or interest by participants in participating in the crowd sourcing activity.

What is needed is an improved system and method for accumulating and verifying trust whereby individual participants are recognized as reliable to correctly and/or accurately complete one or more crowd sourcing activities over time.

### SUMMARY

In an aspect, the present disclosure relates to a computer network implemented system for accumulation and verification of trust for participating users in a crowd sourcing activity. The crowd sourcing activity may include a plurality of tasks, each task including optionally a plurality of sub-tasks. In normal operation, a plurality of users is invited through an open crowd sourced invitation to complete one or more particular tasks or sub-tasks. The present system and method is operable to accumulate and verify trust for each of the participating users and improve quality of the crowd sourcing activity by awarding Trust Scores to participating users, and awarding. Quality Scores to tasks or sub-tasks completed by the various participating users.

In another aspect, the present disclosure relates to a computer network implemented method for accumulation and verification of trust for each of a plurality of participating users engaged in one or more crowd sourcing activities, said method comprising the steps of: inviting the plurality of participating users through an open crowd sourced invitation to complete the one or more the crowd sourcing activities or a portion thereof; and assigning a trust score to each of the plurality of participating users, said trust score being based on completion of the one or more crowd sourcing activities or a portion thereof to indicate a level of trust earned by a participating user relating to the veracity of the completion of the one or more crowd sourcing activities or a portion thereof by each of the plurality of participating users, and said trust score being one of the following: increased if the if the participating user engages in an activity or behaviour that reflects an increase of trust; and lowered if the participating user engages in an activity or behaviour that reflects a lessening of trust.

In yet another aspect, the present disclosure relates to a computer network implemented system for accumulation and verification of trust for each of a plurality of participating users engaged in one or more crowd sourcing activities, said system comprising: a server linked to an application, said server being operable to implement the application so that said application is accessible and operable by an operator; and each of the plurality of participating users, whereby said plurality of participating users engage in the one or more crowd sourcing activities or any portion thereof; and an administrative utility incorporated in the application and operable to implement the one or more crowd sourcing activities or any portion thereof for completion by each of the plurality of participating users and to assign one or more trust scores based on said completion to each of the plurality of participating, said one or more trust scores being based on completion of the one or more crowd sourcing activities or a portion thereof to indicate a level of trust earned by a participating user relating to the veracity of the completion of the one or more crowd sourcing activities or a portion thereof by each of the plurality of participating users, and said trust score being one of the following: increased if the if the participating user engages in an activity or behaviour that reflects an increase of trust; and lowered if the participating user engages in an activity or behaviour that reflects a lessening of trust.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

The invention will be better understood and objects of the invention will become apparent when consideration is given to the following detailed description thereof. Such description makes reference to the annexed drawings wherein:

FIG. 1 is a system diagram illustrating the components, in one representative implementation thereof.

FIG. 2 is a further system diagram illustrating the system, in another representative implementation that includes at least one mobile device configured to enable a participating user to make contributions to the system.

FIG. 3 is a workflow diagram illustrating the steps involved in the network implemented method.

FIG. 4 is a diagram providing a generic computer hardware and software implementation of certain aspects, as detailed in the description.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

The present disclosure relates to an invention that is a computer network implemented system and method for verifying that individual participants complete one or more crowd sourcing activities in a manner that is accurate and/or correct. Further verifying that individual participants can be relied upon to complete one or more crowd sourcing activities in a manner that is accurate and/or correct, and whereby individual participants accumulate trust amongst users in one or more crowd sourcing activities. Trust may be tangibly represented as Trust Scores, Quality Scores, and incentives allotted to individual participants, otherwise known as participating users. The one or more crowd sourcing activities may include a plurality of tasks, each task including optionally a plurality of sub-tasks. As will be explained in more detail, the system and method of the present invention is operable to accumulate and verify trust for each of the participating users. The present invention may improve quality of the crowd sourcing activity by awarding Trust Scores to participating users, and awarding Quality Scores to tasks or sub-tasks completed by the various participating users. Tangible incentives may be provided to the participating users.

In normal operation, a plurality of users is invited through an open crowd sourced invitation to complete one or more particular tasks or sub-tasks. Users responding to an invitation from the system may be referred to as “participating users” herein.

It is useful to explain one or more additional terms used in this disclosure. The present disclosure refers to an “activity” or “activities”, to describe work. Many activities are time intensive, and often involve multiple tasks. Such tasks may be undertaken by a plurality of individuals. The plurality of individuals may be involved either because of the volume of the work involved in the activity, or because in order to complete the activity efficiently, specific tasks involved in the activity are allocated to individuals with characteristics that enable them to complete the tasks in a specific manner. For example, some individuals may complete a task more quickly, or in a way that is consistent with qualitative objectives such as accuracy, consistency, compliance with specific standards, protocols or templates, interoperation with systems, or other factors (“qualitative attributes”). A skilled reader will understand that the present disclosure may enable the application of a wide range of qualitative attributes.

An activity may involve one or a plurality of individuals and may be intended to result in desired outcome. For example, the desired outcome may be: the creation of a product such as a directory, or the enhancement of a product such as an update to a database; or the enhancement of information or knowledge in regards to one or more topics, or enhancement of common knowledge about one or more particular entities. For example, the activities may relate to tracking events, compiling up to date information on a range of topics, or other activities. The desired outcome may relate to the completion of one or more processes for the product such as its validation, testing, verification, or correction. The activity may also relate to subset of a product, such as a particular portion of a directory that has been earmarked for creation, correction or verification. The desired outcome may also include development of a computer program, where a plurality of individuals write computer code components or routines, which are then assembled to provide the computer program. The product may also include a series of images taken of a list of target objects or locations. The product may be the creation of a series of 3D models for a specified list of locations or objects. A skilled reader will understand that the present disclosure relates to a wide range of activities, covering a wide range of domains, where co-ordination of the work of a plurality of individuals is involved.

Traditionally, the work related to such activities is completed by a group of employees or contractors (“activity team”). The costs associated with the engagement of an activity team, and providing said team with the environment to perform their work (for example, such as systems, and possibly office space to enable their management and collaboration) can be prohibitive in some instances.

Also in many domains, new activities or aspects of activities may arise regularly, and the activity team may have been assembled with attributes of one or more specific activities in mind. The skill set or other attributes of the team activity may not however be ideally suited for a new activity or activities, which may result in degradation of the ability to complete activities efficiently. Traditional activity teams may not be sufficiently dynamic to provide an optimal mix of resources to complete the activity efficiently, especially with the definition of new and different activities on a regular basis, or activities that by their nature require a wide range of different attributes in the team members. A more dynamic approach to staffing activity teams is required.

The present invention assembles activity teams efficiently to address a broad range of possible “attributes” (that may be referred to as “participant attributes”). A skilled reader will understand that these participant attributes may relate to any particular attribute that enables the competition of the activity, with the desired outcome. These may include special skills, particular knowledge or expertise, certifications, particular experience, availability or willingness to take on specific tasks, level of interest (because a better outcome may be possible if a team member is interested in the subject matter of the activity or in the realization of the desired outcome).

One embodiment of the present invention may be operable in relation to activities that include location related activities, for example, such as the creation, updating, verification, or correction of a directory incorporating location information. For such an activity familiarity with a particular location such as a neighbourhood, city or other geographic area, may be an important participant attribute of a participant user. This is so because a user who has familiarity with a particular location may be able to complete a task associated with the particular location in a way that is quick, accurate and cost-effective, and thereby consistent with the desired outcome of the present invention.

Furthermore, in relation to location related activities, the participant attributes may relate to the current location of the participant. For example, if a task related to updating a record for a business at a particular location, a participant in the vicinity of the particular location may be well placed to update the record quickly and accurately. The present invention is operable so that participant users may extract information from other sources, for the purpose of verification, updating and correction. A particular participant may have the time to search for and obtain accurate information relating to a particular location, or may be familiar with third party sources that may be accurate for particular locations, and the task may consist of extracting meta data for one or more particular locations and providing this meta data to the present invention. This extraction of data from third party sources may also seed other tasks, for example, such as the correction, verification or updating of the meta data.

Activities, as described in this disclosure, are certainly not limited to management of directories. A skilled reader will appreciate, that the present disclosure may relate to activities covering the general requirements described, in a wide variety of areas, and relating to a wide range of different qualitative attributes. These may include, for example, building a list of available applications such as mobile applications, and/or compiling a set of profiles covering an extensive category of items, such as a set of profiles on movies, music, or celebrities.

However, directories illustrate the problems that the present disclosure addresses, and also highlights the important advantages that the present disclosure provides over the prior art. The present disclosure explains the operation of the system and method in connection with development of directories based on location data solely for the purpose of providing an illustrative example. However, a skilled reader will recognize that the present invention may be directed to applications other than merely directories and a variety of activities other than location related activities.

Directories can be important and valuable data sets. Their compilation in an accurate form can be very expensive, especially given that, for example in the case of a business directory, businesses open and close regularly, and therefore it is important to update records regularly. If a team is formed and dedicated to manage a directory, numerous problems may arise. Personal familiarity with directory records or record sets may improve the efficiency of completion of directory related tasks. However, creating and managing a team to address numerous local databases may involve either: multiple teams at different geographic areas, which adds to the cost and complexity of the activities; or one or more teams with better coverage or some locations than others, but there may be increased costs of engaging in the activities in geographic areas with less than optimal coverage.

Also engaging local contractors for specific activities presents challenges in recruiting and managing personnel locally. For example, given that, due to limited economic resources available to be directed to an activity, personnel engaged for such activities may receive relatively low wages, thee quality of the data received from such personnel may not meet the desired outcomes of the present invention, in that it may not be accurate or correct. This quality may improve by investing in, for example, significant supervision of staff, including using auditing or verification processes, however, this also adds to the cost of the activity and may delay the completion of tasks. Generally, speaking the industry has responded to such challenges in the prior art by engaging significant editorial resources, who verify and correct data or products, again at a significant cost.

These and many other practical aspects of managing directories tend to cause the prior art to result in directories that are relatively expensive to produce, and still have less than optimal coverage and are known to contain a significant number of errors. Also most directories, based on resource limitations, are updated on cycles that for cost reasons are not as frequent as the rate of changes to records (for example, new businesses opening or businesses closing). Directory records tend to become stale and there are few reliable and affordable means to identify which records require updating and when.

At the same time, web and mobile commerce has created a significant demand for data that includes or is based on location data (referred to as “location data” in this disclosure. Most business models associated with web or mobile commerce solutions however, practically speaking, require affordable location data, that is nonetheless accurate. If for example a local directory of businesses points enough users, enough of the time, to a business that has closed, this can have a very negative impact on the directory's business.

The present invention provides an advantage over the prior art in that it addresses issues that limit the accuracy and usefulness of the results of prior art crowd sourcing activities. In particular, the present invention provides tangible incentives to participating users to motivate participation, accuracy of submitted information, verification of information, and other actions that help create the desired outcome of accurate, verified information provided in a cost effective manner. The present invention relies upon means to accumulate and verify trust in activities and tasks completed by particular participant users. The accumulation of trust is between peers. In this manner the present invention avoids the need to engage significant editorial staff or undertake other costly measures to generate accurate and verified information data sets. In one aspect, trust is accumulated and recognized by the incorporation of Trust Scores and incentives in the present invention.

In one embodiment of the present invention, the Trust Scores for each participating user may be raised to indicate a level of trust earned by a participating user amongst his and/or her peers. Correspondingly, a participating user's Trust Score may be lowered if the participating user engages in any activity or behaviour to cause a lessening of trust between the participating user and his and/or her peers. Trust is related to a perceived ability by users to rely upon the participating user to complete one or more crowd sourcing activities correctly and/or accurately. In this manner the Trust Score may be utilized as a means of reflecting the perceived trust that users, who are the participating user's peers, have in the participating user's ability and reliability to correctly and/or accurately complete one or more crowd sourcing activities.

The system and method of the present invention may be embodied in a computer network implemented platform operable so that a platform operator, or a client of the platform operator, may manage the completion of one or more crowd based activities. The platform may be configured to assign one or more tasks or sub-tasks to one or more participating users. More specifically, a task manager utility, one of the components of the platform described in greater detail below, is operable to manage the completion of one or more activities by assigning specific tasks or sub-tasks to the participating users. In a more detailed aspect, the system of the present invention is configured to track progress relating to the completion of the one or more tasks or sub-tasks. The present invention may, based on the current state of progress, assign Trust Score points to one or more participating users. The present invention may further assign Quality Scores to one or more attributes associated with a completed task or sub-task. In the present disclosure, a group of attributes associated with a task is a “profile”.

These Trust Scores may be tracked by the system of the present invention, and incentives or rewards may be issued based on the Trust Scores. These incentives or rewards may then be redeemable for products or services of tangible value to participating users, which may for example, as an option, include financial consideration. “Incentives” in this disclosure refer to incentives that include incentives with tangible value. In this manner incentives of the present invention differ from the social incentives used for example in WIKIPEDIA which do not have any tangible value.

It should be understood that the integration of incentives into a platform based on, or incorporating, crowd sourcing is a novel and non-obvious departure from prior art approaches and solutions.

In one embodiment of the present invention, the platform may incorporate a range of different types of incentives, and the platform (by operation of the task manager utility described below) may enable a range of strategies for motivating specific behaviours of participating users, relevant to completion of tasks and sub-tasks. One aspect of the design of the platform is the use of incentives that are targeted to promote the completion of tasks and sub-tasks in a way that is consistent with desired outcomes, including for example accuracy. Designing these incentives, and implementing these to a scalable platform designed to enable one or more activities, with participation of a significant number of participating users, is not a trivial project. In another embodiment of the present invention, specific processes, routines, or software utilities may be combined to collectively provide a mechanism for motivating the mentioned specific behaviours in a way that is highly efficient and cost effective.

Generally speaking, the incentive types embodied in the platform include “rewards” and “shares” (as described below). The present invention may also assign “penalties” to a participating user in the event that tasks or sub-tasks completed by the participating user are found by another participating user to be inconsistent with defined “quality attributes” (this term is also defined below).

Each participating user may have an account wherein rewards, shares and penalties may be accumulated.

“Rewards” in this disclosure refer generally to incentives that are accumulated by a participating user into his or her account and are provided by the platform for the completion of tasks or sub-tasks. Rewards are credited to the participating user's account. Based on rules defined by the platform, rewards accumulated across several tasks or sub-tasks may be redeemed by the participating user as tangible value. For example, the tangible value may be a product or service, or some other item of tangible value to the participating user. Rewards may be credited to the participating user immediately. In some instanced rewards may not be redeemable immediately (depending on the balance of the participating user's account and other redemption rules). All rewards may be updated immediately (whether immediately redeemable or not), and an update balance optionally may be generated and communicated to the participating user. The update balance may provide a direct incentive that is tied to the behaviour desired to be achieved from the participating user. Structuring the incentives in this manner may take advantage of the added motivation that may be associated with providing immediate gratification to participating users. This is an advantage of the present invention over the prior art.

In one embodiment of the present invention, rewards are generally implemented in the system as “tickets”, as described further below. Rewards may be expressed in amounts in a “virtual currency” as best explained under the Example in Operation set out below. A skilled reader will recognize the variety of means of implementing and expressing rewards in the present invention.

“Shares” in the present invention denote a partial ownership in a product resulting from the activities, for example, such as a library of data objects, a directory, a software program or other product. A share may be based on a percentage of the product based on total contributions to the product. Revenue generated by the operator of the platform associated with the product may result in allocation of a portion of the revenue to the various participating users who contributed to aspects of the product, based on their accumulated shares associated with such contributions. A skilled reader will recognize that many specific mechanisms for variation of the assignment of shares may be applied in the present invention. For example, a total number of shares may be assigned to an entire “record” or “profile”, as explained below.

A record may include a plurality of tasks and/or sub-tasks which may generally correspond to the fields of the record. Specific fields may be assigned the same number of shares, or a varying number of shares, as long as the total number of shares cumulatively for the fields corresponds to the assigned share value for the record. Some fields may involve contributions from more than one participating user in which case the number of shares for the field may be distributed. The number of shares allocated to the one or more participating users who made contributions may be used by the platform to calculate the total participation in the record for the participating users. The platform, in one aspect thereof, is operable to calculate allocations of revenue associated with records, or collection of records, and credit these allocations to the account of participating users. For example, specific attributes may only be associated with participating users that reach specific thresholds of share ownership, such as, for example, a participating user who is a majority shareholder for a record or a portion of the record.

A skilled reader will recognize that other privileges may be possible, for example, such as providing advertising space to a participating user who meets such threshold requirements, free of charge or on a reduced cost basis. The advertising space may be associated with the relevant record. Such participating user may be provided the ability to associate an external link, for example to a record which may provide a higher search engine ranking, for example to an online business or business associated with a web page, in which the participating user may be an owner or a partner. Particularly if the record in question gains importance (for example, such as through a high number of clicks in a product incorporating the record) the benefits provided could be significant. These benefits that may be associated with shares can further increase the perceived value of the shares to the participating users, which in turn may further motivate participation.

One advantage of shares is that they confer “ownership” to participating users and thereby leverage some of the inherent motivations that ownership inspires in many individuals. It should be understood that monetization of the product is often not possible until the product is completed, and which may require significant work, which may be performed over a relatively significant amount of time. Financing the costs of such work, performed based on prior art methods usually involving at least some paid employees or contractors, can be prohibitive.

Shares immediately confer an asset that has intrinsic value to participating users. Yet the obligation to pay the participating users is contingent upon, and deferred to the time of, monetization of the product. The intrinsic value flows from the immediate allocation of the shares that represent a promise to pay a share of real revenue, if this materializes. Pride of ownership is a natural human response for many participating users and can tend to motivate greater investment of efforts, and in some cases on a more timely basis. The concept of shares enables the operator of the platform to seed at little or no additional monetary cost, a broader range of activities than may otherwise be economically feasible.

Shares generally will be assigned to a “record”, as described below, but may be allocated between multiple participating users making contributions to the record. As a specific example, a record may consist of a recipe submitted by a participating user. If significant clicks or downloads are associated with the recipe then significant revenue may be generated. Revenue may be generated through online advertising and other means. As an example, significant clicks or downloads may be associated with the recipe because the recipe gains recognition for its quality. Recognition may be gained, for example, such as through online recommendations distributed through social networks.

The platform of the present invention may be operable to create an online environment that motivates individuals who have high value content to contribute, or the ability and willingness to generate high value content, to gravitate to the environment of the present invention which may be operated by an operator, or to an environment of the operator's clients, rather than to competing environments that do not provide the incentives of the present invention.

In one embodiment of the present invention, the “penalties” are assessed against the particular “rewards” or “shares” associated with the particular tasks or sub-tasks where there has been an error or other failure to meet the quality attributes. Penalties may therefore motivate participating users to verify their contributions and to correctly and or accurately perform crowd sourcing activities. This aspect of motivating the verification or correction of work completed by one or more participating users, by one or more other participating users, may provide surprising improvements in the ability of the platform of the present invention to achieve the desired outcomes. The penalties assigned by the platform introduce accountability to the operations of the system, and in essence make groups of participating users self-policing. For example, groups of participating users may be defined by the platform based on a group of participating users engaging in tasks or sub-tasks linked to the same activity. This concept of penalties, and its application as part of the system of the present invention may reduce the likelihood of completion of tasks or sub-tasks in a way that is not consistent with the quality attributes promoted by the present invention. The result may be that the proportion of incorrect and/or inaccurate records is reduced.

Further details regarding rewards, shares, and penalties are disclosed in connection with the Example In Operation set out below.

While the incentives embodied in the platform serve to motivate participating users to deliver the desired outcomes, ultimately there is a monetary cost associated with rewards and shares. A skilled reader will recognize that the effectiveness of the platform may be enhanced by relying upon other means of motivating desired outcomes from participating users. As discussed herein, social incentives have limited success in initiating rapid deployment of resources from participants in crowd sourcing activities. This has been shown when social incentives are applied in response to a set of targeted activities or related tasks and/or sub-tasks. The combination of incentives of the present invention (for example, such as a combination of rewards, shares, and penalties) represents a significant advantage over the prior art.

In one embodiment of the present invention, the platform may be operable to provide another means to motivate participating users, either in combination with incentives or without incentives. Such an embodiment of the present invention may engage the participant users' interest in competing with one another in the context of a game defined by one or more rules. In such an embodiment of the present invention, the platform may be configured to include or embody one or more operations, mechanisms and/or interfaces that relate to one or more elements of gaming mechanics. Said gaming mechanics may be integrated in general activities initiated by the platform and may relate to the completion of the task and/or sub-tasks. “Game mechanics” may be defined herein as the rules, game designs or other attributes that contribute to individuals having a fun and engaging experience in playing a game.

In one embodiment of the present invention the platform is directed at managing the completion of tasks or sub-tasks based on crowd sourcing with a gaming aspect or component. The gaming aspect or component introduces competition into the collaborations enabled by the present invention whereby groups of participating users work together and each make contributions to the activities by completing tasks or sub-tasks. This unique integration of collaboration and competition introduces a new concept, namely of “competitive collaboration”.

The present disclosure describes a computer network implementation of a competitive collaboration embodiment of the present invention, wherein the platform enables the management of completion of tasks and sub-tasks by the crowd. The motivation of participating users from the crowd is generated in part by linking the completion of tasks or sub-tasks to one or more gaming elements. In such an embodiment of the present invention participating users compete to achieve scores higher than the scores of other participating users. Scores are determined based on points allocated for completion of particular tasks or sub-tasks.

The competitive collaboration embodiment of the present invention combines crowd sourcing and gaming elements offers an advantage over the prior art. The prior art does not combine crowd sourcing and gaming elements. This embodiment of the present invention produces significant and surprising improvements in the ability of the platform (and the related methods) to cause the participating users to achieve the desired outcomes efficiently. Examples of implementations of embodiments of the present invention that incorporates gaming elements are provided below.

It should be understood that the system and method or the present invention may involve: (a) the crowd sourcing aspect, with incentives as described; and/or (b) a crowd sourcing component combined with one or more gaming elements.

The platform of the present invention may be configured to enable the operator, or clients of the operator, to deploy one or more campaigns designed to motivate completion of tasks or sub-tasks efficiently. The platform may further be operable to deploy one or more campaigns in a way that is responsive to a number of desired outcomes, for example, such as prioritization of specific activities, or tasks or sub-tasks, including based on revenue opportunities, time sensitive campaigns requiring specific information sets, etc. These campaigns may be either designed based on one or more known attributes, or may be designed on the fly. Also, campaigns may be optimized based on the results delivered by the crowd activities by dynamic modification of the campaigns by operation of the platform. In design of such campaigns, deployment of these campaigns, and optimization of campaigns during their deployment, it is desirable to incorporate in the platform a range of tools for motivating the participating user behaviour.

In one embodiment of the present invention, a range of tools may be provided to function with incentives and gaming elements. The tools may be varied and may be combined by operation of the platform (as described) to enable targeted motivation of participating users. Such targeted motivation of participating user may achieve efficient and quick completion of tasks and sub-tasks, and creation of products based on the work completed. As a result, products (for example, such as directories, software programs, or other collaborative projects) may be completed with improved quality and at a lower cost.

Furthermore, the platform (and related methods) may be operable to allow the operator of the system, or its clients, to engage in a broader range of collaborative activities than is possible based on prior art methods. This allows the present invention to provide significant advantages over the prior art, because prior art methods generally require decisions to engage in some activities and to not engage in other activities. The decisions of the prior art are based on prediction of which activities are likely to result in the best revenue generation outcomes. The present invention is operable to motivate participating users to achieve efficient and quick completion of tasks and sub-tasks, and to undertake these tasks so as to work in a collaborative manner. This has the result of achieving completion of projects with improved quality and decreased cost.

Furthermore, prior art methods usually require decisions on a specific number of activities, likely based on prediction of which activities will result in optimal return on investments. This may require concentration on a smaller number of projects and may limit the scope of activities that would otherwise be possible. The present invention does not require such concentration on a small number of projects, but provides for significant contributions to a potentially numerous variety of projects.

Another drawback of the prior art methods is that it can be difficult to accurately predict the specific products that are likely to provide stronger revenue potential. This is a problem because of the significant focus of the prior art methods on predicting activities that will result in optimal return on investments. The present invention provides a platform where a broader range of activities may be enabled than is possible by the prior art. In the present invention, some activities may be initiated by the interest of participating users. The interest of the participating users may provide a good indication of activities that may have revenue potential. Such activities may expand organically and thereby create value that would not have been generated based on a centralized, managed approach as is applied in the prior art. In this manner the present invention offers a significant advantage over the prior art.

In one embodiment of the present invention, the task manager utility may be operable to initiate the creation and distribution of an open crowd source invitation. The invitation may take a number of different forms, and may be distributed in a number of ways. For example, the invitation may consist of posting a task or sub-task on a web page, for example a web page related to an activity. The activity, or the associated tasks or sub-tasks may be promoted for completion by means of communication to the crowd, for example, such as by email. The platform may be operable to match activities, or their tasks or sub-tasks with particular groups of users based on attributes that may result in the desired outcomes. Activities may be matched, for example, such as based on interest, location and/or other attributes. In particular, the platform may include one or more specific utilities or processes for targeting tasks or sub-tasks to specific users, as is addressed in a separate patent disclosure of the Applicant.

In another embodiment of the present invention, a mobile application linked to the platform is loaded on a mobile device of a user. The mobile application may be operable to obtain, for example, such as on a pull basis, one or more data elements that relate to one or more activities that may be of interest to the user. These data elements may be used by the by the user to initiate a request for one or more tasks or sub-tasks for completion by the user.

Tasks or sub-tasks may be completed using a suitable utility for providing the participating user's contribution, for example, such as defined requirements that the information submitted must meet. A utility for providing the participating user's contribution may be a task completion utility. The participating user may be associated with a variety of types and numbers of network-connected computer devices. The network-connected device may a computer device such as a desktop computer, laptop computer, tablet computer or other similar device that is connectable to the platform via the Internet. For example, the device may be connected to the platform via the Internet by means of a browser session. The platform may access one or more web forms that may correspond to the record described below, or an aspect of the record. The participating user may provide the information requested by the web form. The web form may be communicated to the platform, for example, such as when a button, (e.g., a “SUBMIT” button, or other button) or equivalent is clicked or otherwise engaged. The content of the web form may be communicated to the platform for integration into one or more system initiated workflows embodied in the record.

The network-connected device may also be a mobile device such as a smart phone, and completion of task or sub-tasks may occur by means of a mobile application loaded to the mobile device or smart phone. Further implementation details of such an embodiment of the present invention are provided below.

The mobile application may be operable to deliver the user's contributions to the platform of the present invention. The user's contributions may be integrated into the workflow implemented by the platform for completing the various tasks or sub-tasks. Further details on this aspect are explained below.

The task completion utility may also provide to participating users one or more tools to enable collaboration between participating users in regards to completion of tasks or sub-tasks. For example, a task completion utility may be operable, before submission of participating users' information to the platform, to: recognize participating users' information elements as a possible duplicate; and/or enable participating users to make suggestions for possible information elements for comment by other participating users. The participating users may also provide possible suggestions for corrections to information elements, prior to submission. This may be to arrive jointly at correct answers and possibly suggest changes without incurring rewards/penalties as explained below. This may possibly represent a form of courtesy offered from one participating user to another.

The prior art (including known technologies and solutions) does not provide a way to manage the completion of tasks or sub-tasks involved in such activities (including, for example, the updating a local business directory) that yields data of acceptable accuracy. Nor does the prior art disclose a solution for ensuring that the activity or activities are completed in a way that is efficient enough to enable operators to access the products (in this case an updated directory) in a way that is affordable. The deficiencies of the prior art are aggravated by the fact that while businesses leveraging, for example, location data, can generate significant revenue over time, often through advertising data, a significant user base is often required before revenue reaches a point where accurate data (obtained based on prior art methods) becomes accessible to operators. Also, capital to fund access to expensive yet accurate location data is often difficult to obtain while revenues are weak. This results in the launch of web and mobile commerce platforms that have the potential to provide significant benefits to users, but adoption suffers without access to accurate data. This may result in the failure of what would have otherwise been viable businesses. This particular example, based on location data, illustrates the need for a better solution as is offered by the present invention that completes tasks or sub-tasks, with participation of a plurality of individuals, on a more efficient basis, yielding better products and outcomes, including better and more affordable location data.

Collecting up-to-date data, for example, such as location data that incorporates business profile information, on a global scale may generally require the following inputs:

1) participation of local participants to tap into their local knowledge (as opposed to centralized employees who will require greater resources to discover changes);

2) active participation of these local participants to keep up with the rate of change of such information (businesses in any community frequently open, close, and change their information); and

3) accurate data (in order to avoid for example mapping products inaccuracies, which may result in users perceiving that they have been misled).

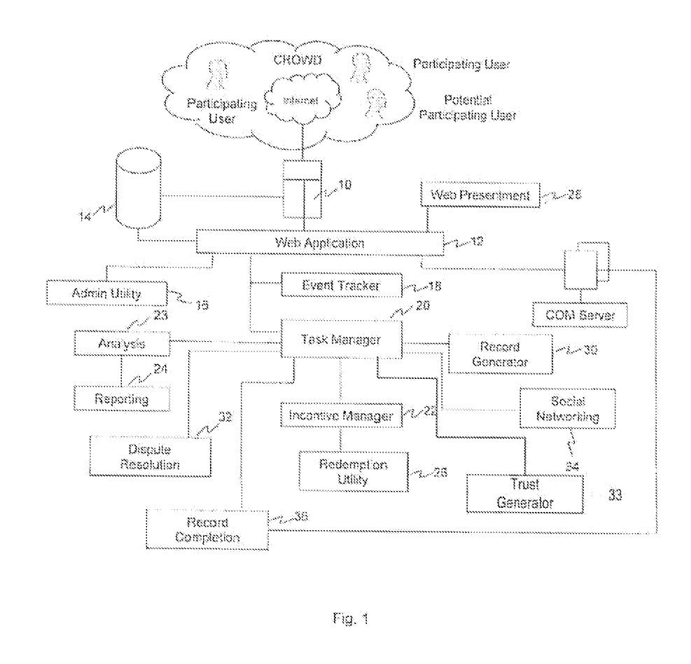

The present invention is operable to facilitate the collection of up-to-date data that engages participant users to provide such inputs. In one embodiment of the present invention, as shown in FIG. 1, the platform is implemented as a web application. The present system may include at least one web server (10). The web server (10) is operable to run the web application (12). The web server is linked to a database (14).

It should be understood that the present system is not limited to any particular computer network implementation. FIG. 1 illustrates only a representative implementation of the system of the present system. It should be understood that web server may be implemented in other embodiments of the present invention by means of a distributed computer network architecture, server farm, or cloud network.

In addition, while the disclosure provides certain details regarding one or more computer program aspects, the functions of the computer program are explained without limiting the application to any particular computer program architecture. Each functional component may be implemented as part of a computer program module with multiple functions, or may be implemented as including one or more other functional components. A skilled reader will understand that numerous possible implementations are contemplated.

The web application (12), as shown in FIG. 1, may include an administration utility (16). The administration utility enables participating users to register with the system, and establish their profiles on the database (14). The administration utility (16) is operable to update each profile with rewards, shares or associated penalties.

The web application (12) also includes an event tracker (18) which enables the tracking of each user activity of a participating user in connection with the platform. The event tracker (18) supports a number of other operations and elements of the platform, including the task manager (20). The task manager (20) is best understood as a back-end, administrative utility, that enables the operator of the platform, or third parties authorized by the operator, such as operator's clients, to design and deploy one or more activities or associated campaigns, and the tasks or sub-tasks that are linked with such activities, by operation of the platform. Deployment of activities on the system triggers creation of tasks and sub-tasks as explained in this disclosure.

The system also includes an incentive manager (22) which may be an aspect of task manager (20) or a utility linked to the task manager (20). The incentive manager (22) enables the operator, or the operator's clients, to associate one or more incentives with the tasks or sub-tasks. For example, the incentive manager (22) may enable administrative users to: (A) select from a range of types of incentives (including for example rewards and shares as explained above); (B) select the value of such incentives; (C) select penalties to be associated with specific incentives; (D) select the value of such penalties; and/or (E) select one or more gaming elements, and the link between such gaming elements and the incentives and/or penalties. In addition, the incentive manager (22) enables the administrative users to establish the specific domain of application of (A), (B), (C), (D) and/or (E), which may consist of the following domain of application components, namely a specified field in a record (see below), one or more tasks or sub-tasks, or one or more activities. The domain of application may be selected by the administrative user using a suitable incentive manager graphical user interface, or may be selected from a list of such domain of application components generated by the platform based on one or more associated criteria selected by the administrative user, for example all “OPEN” domain of application components related to “FIELD A” (for example a restaurant directory) with “PRIORITY X” (which may be based on associated revenue opportunities).

The incentive manager (22) may include or otherwise incorporate one or more templates that define default incentives or gaming elements based on the nature of the activity and/or historical data indicating performance relative to desired outcomes based on the nature of the activity. Administrative users of the platform may modify incentives and/or gaming elements to achieve desired results such as improving accuracy through expanded verification/correction, additional incentives or gaming outcomes for providing specific detail, or completing tasks or sub-tasks within certain time frames.

The task manager (20) may also be linked to, or include, an analytics engine (23) that is operable to analyze a plurality of operations of the platform, including metrics related to the completion of tasks or sub-tasks, such as for example the demographics of participating users who complete certain types of tasks or sub-tasks, rate of completion of specific activities, projected time of completion of an activity, etc. The analytics engine may be operable to reveal insights that enable optimization of incentives. For example, the analytics engine may be operable to run test scenarios to reveal that at a certain time of day, in a certain location, with a particular group of participating users, a lower level of incentives is sufficient to produce the desired outcomes. A skilled reader will understand that an analytics engine that incorporates known optimization techniques can provide effective optimization of incentives used by the platform to achieve desired outcomes thus improving efficiency. For example, the analytics engine may enable the generation of data regarding the rate at which tasks are completed, may provide information enabling the rebalancing of rewards, or enable the tracking of completion of campaigns.

The analytics engine may be used to test incentive scenarios to predict or estimate the impact of modification of incentives or gaming elements on achievement of desired outcomes.

The analytics engine may be linked to a reporting utility (24) to generate one or more reports. For example, the reporting utility may enable administrative users to generate a report analyzing the incentives provided to and/or gaming elements assigned to particular users, and the resulting behaviour of such participating users. A skilled reader will understand that analyzing the motivators especially for a group of participating users responsible for a significant proportion of completed tasks or sub-tasks may yield significant opportunities for optimization of performance of the platform. The functions of the analytics engine and the reporting utility may be used to enable dynamic changes to the incentives and/or gaming elements to improve performance of the system relative to the activity objectives, by operation of the task manager.

In one embodiment of the present invention, the incentive manager (22) is operable enable the allocation and calculation of a virtual currency for applying rewards (as described above) in connection with tasks or sub-tasks enabled by the platform.

The system may also include or be linked to a redemption utility (26) that enables the conversion of the virtual currency into monetary currency or the purchase of products or services based on the virtual currency. The redemption utility may include or be linked to a transaction server (not shown) for processing transactions related to the redemption of virtual currency. A skilled reader will understand that various mechanisms for redemption are contemplated. An example of such a mechanism is described below under the heading “Rewards”.

The incentive manager (22) is operable to generate a “ticket” in response to a participating user completing a task or sub-task defined by the system. The event tracker (18) detects the completion of the task or sub-task. This information is provided to the incentive manager (22), which updates the profile of the participating user to reflect the accrual to his or her allocation of rewards.

The system may also include a web presentment utility (28) for generating and publishing one or more web pages, such as for example web pages incorporating records (explained below) or web pages used to generate the provide access to the one or more prize redemption pages referenced below.

In another aspect, the platform is configured to enable the dynamic modification of incentives in order to achieve desired outcomes, without, for example, alteration of the workflow involved in assigning tasks or sub-tasks to specific participating users, or in completing tasks or sub-tasks, and without the need for significant work to implement changes for example in terms of software configurations or database configurations. The dynamic modification aspect is enabled by the record manager (30) aspect of the task manager (20), which is explained below. As previously described, incentives allocation by operation of the platform may include, rewards, shares, and associated penalties.

In still another embodiment of the present invention, the event tracker enables the monitoring of progress of the platform in initiating the participants to completing the task or sub-tasks.

The incentive manager (22) is operable to access one or more parameters regarding desired outcomes, such as for example priority of clients of the operator, such as the scope of activities, or associated tasks for sub-tasks, compensation paid by the clients. The incentive manager, in one aspect thereof, enables the operator, or one or more clients of the operator, to develop one or more campaigns with a view to motivating the crowd to complete a series of tasks. Based on performance relative to campaign goals, an administrative user may modify the incentives, or the platform may dynamically modify the incentives.

By operation of the incentive manager, the system enables participating users to check the work of other participating users, and if errors are found or suspected, to correct the information.

A skilled reader will appreciate that many possible examples or rewards/shares/penalties are possible, as well as many possible gaming elements. The disclosure, including the Example in Operation below, provides only a few examples that serve to illustrate the various possible particular incentive or gaming element implementations, based on the platform and related methods disclosed herein, and these are provided merely as examples of some possible embodiments of the present invention.

Rewards

As explained previously, rewards may be implemented as “tickets”, which may be collected and then in one implementation placed into draws or raffles for prizes, by operation of the redemption utility. The platform may be operable to generate one or more lists of prizes, and then sub-sets of these lists may be associated with one or more particular tasks or sub-tasks, or record fields (as explained below). The platform may generate for participating users sub-lists dynamically, and communicate these sub-lists to participating users on a regular basis, such sub-lists including prizes currently available for which the participating user is eligible. Such communications or other similar communications may be used to invite the participating users regularly to one or more prize redemption web pages presented by the system. The one or more prize redemption pages enable participating users to select one or more links associated with specific prizes, and these links may be operable to debit the account of the participating user and enter the participating user into the draw, subject to the applicable draw rules which may be accessed via the prize redemption web pages.

The prize redemption web page may change regularly and may include from time to time particularly desirable prizes, available in draws with improved odds and/or for an attractive number of tickets, so as to provide one or more “special prizes”. These and other mechanisms may be used to attract participating users to the prize redemption page or pages on a regular basis. The more the participating users return, the more they are likely to use their tickets, the more they use their tickets the greater the need to generate more tickets. Alternatively, one or more highly desirable prizes are presented, with associated draw rules designed to motivate the participating users to engage in high priority tasks or sub-tasks.

In one embodiment of the present invention, the greater the number of tickets submitted into a draw the better the chance of winning, however, a single ticket may be sufficient to win the draw. This motivates participating users to generate tickets, but also prevents participating users with a lesser number of tickets from being discouraged and perhaps withdrawing from completion of tasks or sub-tasks.

It should be understood that the incentive manager enables administrative users to tune incentives, including for example prizes and associated redemption rules to for example ensure that key participating user groups continue to be motivated.

Shares

In a still further embodiment of the present invention, the incentive manager is operable to allocate a virtual asset based on contributions to the completion of a task or sub-task. The virtual asset confers an “ownership” or “partial ownership” interest in a product or a component thereof such as a specific record of a directory. The virtual assets can be configured to provide a significant future value.

In a still other embodiment of the present invention, the platform may include or provide a virtual stock exchange that enables the trading of shares created by operation of the system. Shares may for example be traded for tickets, or shares related to one record may be traded for shares related to another record, and so on.

Penalties

In another embodiment of the present invention, the incentive manager includes or embodies one or more processes for promoting accountability among users and thereby decreasing the likelihood of users failing to complete tasks or sub-tasks in a manner that is consistent with the qualitative attributes. One aspect of this is the assessment of penalties if, for example, participating users complete tasks or sub-tasks but in a way that does not meet the qualitative attributes.

Various penalties may be incorporated in embodiments of the present invention. For example, penalties may involve the removal of tickets and/or shares, as applicable, from the account of a participating user in the event that another participating user corrects the information elements that resulted in tickets being allocated to the first participating user. The penalty may be a portion of, or multiple, of the tickets allocated to the first participating user. The amount of the tickets may be allocated to the second participating user making the correction. Penalties of this nature may be useful to reduce the likelihood of frivolous corrections. And also it is useful to have a mechanism for resolving disputes regarding whether the information elements meet the quality attributes or not (for example is an entry to a field of a record accurate or not).

One embodiment of the present invention may incorporate an incentive manager operable so that a participating user challenging whether an information element meets the quality attributes may be required to post a bond based on a specified amount of his or her tickets and/or shares pending confirmation of whether the challenge is appropriate, for example based on verification by the operator of the platform, or pending outcome of a dispute resolution routine. The bond may be advantageous in that the challenger may consider its challenge more carefully, and for example verify the correct information, prior to issuing the challenge which tends to promote the desired outcomes.

The challenge may involve a formal challenge, which results in a communication to the first participating user, who may have a defined period of time to respond to challenge, and if no reply is received then the challenge may succeed. Alternatively, any challenge may be immediately referred for dispute settlement whether the first participating user responds or not.

A range of dispute resolution mechanisms is possible, which may be implemented by operation of a dispute resolution (32) utility that is part of the platform, as shown in FIG. 1. For example, disputes may be referred by the platform to an editor, or a participating user who has made significant contributions in an information area relevant to a dispute.

Trust

As described above, the system offers rewards to users for adding data by undertaking the completion of a task or sub-task. Given that it is easier to add inaccurate data than to add accurate data, there are always some users who will attempt to take advantage of their anonymity to provide inaccurate information to the system. Thus, there is a need for a system to determine which data added is valid, and which users contributed the valid data so that they can be appropriately rewarded.

In addition to measuring the quality of data added and the contribution of users, it is also important to develop a system that can determine how recently information had been verified for compliance with the quality attributed, for example, such as verified for accuracy by other participating users.

As participating users, by operation of the platform, are constantly reviewing pages and seeking out inaccuracies, the system cannot just rely on the date when the data is added. It would be inefficient to ask participating users to continue to review older information that had been recently reviewed and validated by a trusted user. Therefore, the platform of the present invention is configured to dynamically reprioritize information established for review by the platform, based on how long it has been since it was last verified. A novel and innovative trust system was created by the present inventors to address both of these goals.

In one embodiment of the present invention, the system tracks the accumulation of reputation (credibility, trust, etc.) of users, and also tracks the quality of information based for example the time it was last verified and the level of trust of the user who verified it. The purpose of the system is to filter out low quality data, pay rewards to deserving users, and direct users to information in need of review.

The trust aspect described in this disclosure may be implemented as a component that may be part of the incentive manager (22), or a component linked to the incentive manager (22), for example a trust allocator (33), as shown in FIG. 1. The trust allocator (33) may be operable to establish and update the Trust Score as part of the profile of the participating users of the system, and to establish the Quality Score in co-operation with the record generator (30) described below.

In one embodiment of the present invention, each participating user may have a Trust Score, while information associated with the platform (for example information stored by means of the records described below) is linked with a Quality Score. Quality Score represents a quantitative measure, established by operation of the system, for the level of trust that exists that particular information meets the quality attributes, based on Trust Score associated with the particular participating users that contributed to the creation, modification, and verification of information.

A participating user accumulates trust as a Trust Score when information that they have added is verified by an already trusted participating user. Information collected by operation of the present system accumulates quality when it is verified by a trusted user. Trust and quality are relative concepts and enable a comparison of one user to another, or one data field to another. The operator of the system can set levels by which users are deemed to be fully trusted, and data is deemed to have full quality, and relative to this level the system may enable the definition of a Trust Score that is equivalent to a number smaller than the fully trusted level. Minimum levels of trust may also be established.

In one embodiment of the present invention, participating users lose trust when data they have verified is accurately corrected by another user and for other similar activities. As well, data loses quality due to the passage of time (as the longer it has been since it was verified, the more likely it may have changed and needs an update).

In another embodiment of the present invention, to reduce attempts to game the system or to “manufacture” undeserved trust, various limits and restrictions are incorporated into the system. These limits may include restricting how much trust can be accumulated by a user from another user, and disincentives to accumulate trust in multiple accounts rather than in a single account.

In another embodiment of the present invention, a user's Trust Score may affect their status, rights and permissions including access to prizes and payments, and other activities that are limited to only trusted users. It may also affect the rewards received by users who invited them.

In an embodiment of the present invention, a Quality Score may be associated with each field of a record, and the various Quality Scores may be compiled to establish a Quality Score for the profile itself. Quality Scores may affect how records, or components thereof, may be: (a) displayed and exported to third parties; or (b) prioritized and displayed in the system for review by users.

As an illustrative example, displayed next to each confirmable quality attribute may be an option or button to indicate that the user has reviewed and verified the information. A skilled reader will recognize that the system could display a plurality of selectable options, such “like”, “vote”, or “correct”. Selecting a “like” option may indicate strong approval, a “vote” button may indicate moderate approval, and “correct” may indicate a need to identify an error or a failure to attain a minimum level of quality. It will be appreciated that these selections are illustrative, and there may be a higher number of selections to cover a wider range of approval or disapproval. Depending on the quality standard associated with a particular task or sub-task, certain buttons may be enabled, disabled, or highlighted. In one aspect of the invention, the web presentment utility (28) may enable this display of the relevant Trust Scores or Quality Scores in relevant web pages, as shown in FIG. 1.

In one embodiment of the present invention, when a user clicks a “confirm” button associated with an item of information, associated for example with a field in a record as described below, his/her Trust Score or a portion thereof may be added to the information's or field's Quality Score, up to a set maximum. All or a portion of his or her Trust Score may also be added to the attribute owner's Trust Score

In the present illustrative embodiment, a participating user may obtain a Trust Score up to a maximum of 1000. If their Trust Score were 500, then when they clicked the “confirm” button, 500 Quality Score points would be added to the applicable field, attribute or record. A percentage of their Trust Score (say, 1% or 5 points) would be added to the attribute owners' Trust Score. There may be a limit as to the number of times overall that one user can add Trust Points to another user.

For making a selection on a confirmable information element or contents of a field, completed by another user, the reviewing user also may receive a reward. In the present embodiment, this reward is calculated based on an equation, such as:

Reward in tickets=Quality Score contributed by that user/max Quality Score×ticket reward for editing that attribute x an arbitrary multiplier

On the other hand, when “correct” is selected by one or more participating users, notification of the “correct” selection may be sent to all potential voters (i.e. users who have been identified by the system as being qualified to vote in one or more circumstances, and these circumstances are matched by the system to the even of “correction” as described). In an embodiment, any of voters can dispute the correction. If a correction is ultimately applied, a penalty may be assigned by the system against all the voters who disputed the correction and all voters who requested the correction may get receive a reward, which may be based on the applicable Quality Score. As well, the Quality Score for the information element or record field contents may be reset to 0, and the participating user who may have created or modified the information element or record field contents may lose a predetermined number of Trust Scores.

In one embodiment of the present invention, if a user's score goes down due to a correction, or by calling for a correction when none is required, any other allocations to the Trust Scores of other users or to the Quality Scores of other data set to decrease proportionally. However, to avoid system overload in case a user has cast hundreds or thousands of votes, this reduction may be limited by time, or by number. For example, the ratings may be reduced for the last X people, and last Y fields the user voted for. As will be appreciated, this may result in approximate scores for all users over time.

Every information element or record field content (including multiple choice options) can be set by an administrative user to be eligible for verification, as a property thereof. For example, this property can be set in the meta schema file that defines every record field. By default, the Quality Score may be set to zero until it is verified by a user with a sufficient Trust Score.

Each user's Trust Score may be is stored in the database (14) and referenced by their account ID. When a user joins, they have no accumulated trust, so their score is set to zero. However, in an embodiment, system administrators can arbitrarily increase or decrease a user's Trust Score as may be necessary.

In one embodiment of the present invention, information elements or record field contents eligible for verification may be identified by a suitable marker, such as a “Verify It” button appearing beside a data attribute by operation of web presentment utility (28). The button may be offered and displayed to a particular user when: (a) the information element or record field content was added by another user and is not currently locked; (b) the information element or record field content may not have yet accumulated maximum quality, as defined by the incentive manager (22), as shown in FIG. 1 (either because not enough users with sufficient Trust Scores have validated it, or because some time has expired since it was verified); and (c) that user has sufficient trust to be permitted to verify information element or record field contents.

If the user selects the button to indicate that they have verified the particular attribute, then the following steps take place:
(1) the date and time, plus the verifying user's ID is recorded;
(2) a portion of the verifying user's Trust Score is accumulated by system as a contribution to the Quality Score, up to the Quality Score limit per attribute (the contribution ratios and limits are set by the system administrator);
(3) a portion of the verifying user's Trust Score is accumulated by the user who added the data as a Trust Score, up to the user-to-user accumulation limit (the contribution ratios and limits are set by the system administrator); and
(4) the verifying user receives a reward that depends on how much Quality Score that user contributed to the attribute, the value of the attribute as assigned by the system, and that user's own Trust Score.

When an information element or record field content is corrected, the system reduces the Trust Score and deducts rewards from the user who provided the relevant information element or record field content, or modified same as the case may be, along with the users who had verified it, pending the outcome of the correction. All of the users who are affected by a correction are notified and have an opportunity to defend the data and dispute the correction, which may occur as a function of the dispute resolution utility (32), as shown in FIG. 1. If the correction is later determined to be invalid, the trust and rewards are restored, with the possibility of an additional bonus to compensate them for the trouble of having to defend correct data. If an information element or record field content is later rolled-back and deleted, the Quality Score of the former value is restored. Therefore in one aspect of the system, previous Quality Score levels are stored to the database (14) in the event that such roll-back is required.

In one embodiment of the present invention, the penalties deducted for a valid correction are determined by the value of the attribute, the time expired since the attribute was added or verified, and the particular user's benefit previously obtained by adding or verifying the attribute. Typically, the penalties for adding incorrect data may be set to be many times greater than the rewards for adding or verifying data. When an attribute is corrected, its Quality Score is reset to zero.

In another embodiment of the present invention, in recognition that data changes over time, the Quality Score may be set to degrade over time based on the time since the record, or record field, was last verified. For example, the system may consider the time expired since each user verified the record, or record field, and that person's Quality Score contribution at that time. As the Quality Score degrades, a user who has not yet verified the data can contribute the greater of (a) the available Quality Score points, or (b) his Trust Score. A user who has already verified the information element, record or record field content, can contribute the greater of (a) the maximum of available Quality Score points, or (b) the portion of his contribution that has since degraded.

To avoid situations where a user accumulates trust from users who have themselves improperly accumulated trust, the system may dynamically reduce a user's Trust Score if the Trust Scores of the users who have contributed trust to that user have been reduced (either through site activities or by administrator action, or both). As well, a user may lose trust if they only verify data to motivate that user to continue adding new data.

To keep users informed of their trust metrics, the system may display the following in reports:
1) each user's Trust Score is displayed next to their nickname;
2) each user can view (for themselves and for any other user) any data qualitative attributes that were verified, the trust a user has contributed to other users, and the trust that other users have contributed to a particular user; and
3) for each profile (a group of data qualitative attributes), each verified attribute is listed along with the users who have verified it and the accumulations of quality score contributed by each user to that attribute.

Trust Scores may be used in various ways, including setting the rights, privileges, and compensation of users. For example, users may be prevented from receiving payments if they have insufficient trust. Trusted users may have access to better rewards (for example higher levels or more attractive redemption rules), and trusted users can help resolve disputes or otherwise gain status in the community. Trust Scores may also impact the tasks or sub-tasks that a system assigns or makes available to users, with trusted users being given tasks with more weight, and the opportunity to be rewarded more when completing their assigned tasks or sub-tasks. Trust Scores can also help to identify spam or to flag suspicious user behaviour, by requiring in some cases minimum Trust Scores before accepting contributions by participating users, and to flag suspicious user behaviour.

In one embodiment of the present invention, the Trust Scores of a group of users may affect how many users the system needs to ask to complete a task or sub-task. For example, based on quorum criteria, the higher the Trust Score of the available users, the less of them the system needs to invite to engage in tasks or sub-tasks. A user's Trust Score is raised for successful completion of tasks or sub-tasks, and a User's Trust Score is reduced for unsuccessful completion of tasks or sub-tasks.

In another embodiment of the present invention, Quality Scores may be used to filter data and to prioritize data or profiles (a group of data qualitative attributes) for review. For example, information elements or record field contents having low Quality Score may be filtered from third party view to prevent inaccurate data from being disseminated. Information elements or record field contents associated with a relatively low Quality Score may also be prioritized to be verified by a trusted user as a task or sub-task. Furthermore, profiles with a low Quality Score can be highlighted in search results to encourage users to review and verify it.

A powerful feature of the interplay between Trust Scores and Quality Scores is that the system does not need to have users actually verify all aspects of compliance of the information elements or record field contents with the Quality Score. By having users verify a small sample size, a Quality Score can be implied for information elements or records that have not yet been checked, by referring to the current Trust Score of the user who added it. The system can also create a task or sub-task to have users verify a random sample of a particular user's contributions to create a Quality Score for the rest of that user's contributions. This makes it efficient to process and verify a large volume of information or records quickly.

Another benefit of the present system is that Quality Scores have a corresponding date/time stamp to let customer know when the information elements or record field components were last verified. This is important when the information is of a type to lose its accuracy relatively quickly, requiring more frequent verification.

Illustrative Use Cases:

Various illustrative use cases will now be described. In an embodiment, the system may track in a user's account the “actual” Trust Score of a user, which may be above 1000. However, all operations as described above may be limited to using a Trust Score of 1000 as a maximum.

A) When one or more information elements or record field contents have a sufficiently high Quality Score, and an associated date on which it was last modified, the “confirm” or “Verify It” button may be initially disabled. However, with the degradation of the Quality Score over time, upon reaching a predetermined threshold, the “confirm” button may be enabled to allow users to review the information elements or record field contents once again. In this manner, only information elements or record field contents with lower Quality Scores requiring review are presented for confirmation.

B) When a “confirm” button is clicked by a user, the attribute's Quality Score is verified. If the Quality Score is at a maximum, or the is information elements or record field contents under correction, then the system may stop further action, and optionally display the reason for stoppage. If the system proceeds, then the system may adds Quality Score points to the information elements or record field contents. The system may then proceed to add Trust Score points to user. When a user clicks “confirm”, the user may also lose a portion of his/her Trust Score.

C) When a correction occurs, all users who have confirmed the attribute are added to a “correction affected users” list. The system then withdraws a penalty from the users, and display corrections in the “correction to you” section, send notifications (e.g. via emails), and allow disputes.

D) When a correction is applied, the Quality Score may be automatically reset to 0, because a new information elements or record field contents is created. The system then withdraws Trust Score points from the corrected user, and from the users who verified or confirmed the attribute based on same formula as a ticket penalty.

E) If a user's Trust Score goes down X % from a maximum Trust Score of 1000, the system can proportionally reduce his/her contribution to a predetermined number of Y previously contributed attributes, and Z last users to whom he/she contributed Trust Score points.

F) When the system rolls back an attribute, its Quality Score should be restored. Tickets are not withdrawn.

G) An administrators' panel can be used to add and deduct Trust Score points to/from a user, including the last X data qualitative attributes he/she voted for, and the last Y users he/she voted for. The system can also remove all contributions made by a user.

H) After a Quality Score stays “current” for a predetermined number of X days, it starts degrading. After Y days, where Y>X, the Quality Score may be calculated based on a function, such as <QS>−(Y−X)*<degrade_property>. After degradation starts, when not voted on yet, a user can contribute a maximum of the available points and his Trust Score. If already voted on, a user can contribute maximum of available points and his degraded contribution.

I) After a predetermined number of days, such as 6 months, votes may be deleted, but score points previously allocated may stay unaffected. As result a user can perform multiple contributions to the Quality Score and Trust Score for a given attribute over time.

Gaming Elements

The platform includes or embodies one or more processes or features that enable participating users to engage in “competitive collaboration” as previously explained based on one or more gaming elements. These gaming elements are best understood as one or more particular aspects of the incentive manger (22), as shown in FIG. 1. These may include for example publication of statistics regarding particular participating users with relatively high scores based on winnings (by redeeming tickets), based on total tickets earned, total shareholdings, total revenue generated based on shareholdings and other metrics that may inspire performance and perhaps competitions between participating users generally, and perhaps between particular groups of participating users in order to create rivalries within specific groups. Such competition and particularly rivalries can encourage increased levels of activity.

The gaming elements may be enabled in party by a social networking engine (34) linked to the incentive manager (22) for enabling participating users to organize into user initiated groups, in part to track reward/penalty/shares performance within one or more groups, initiate particular challenges and the like.

Records

The completion of tasks or sub-tasks by operation of the present invention, may occur by means of a “record” created by the system. In the present disclosure, the record is analogous to a smart form, and may be implemented as a meta file, typically including one or more fields for submission of information (whether text, computer code, images or any other data—referred to as “information” in this disclosure), where the record also may embody one or more attributes for one or more of the fields. These attributes may relate to a relationship between two or more fields. The relationship may be defined by hierarchical relationships between fields, for example parent-child relationships between them. The relationships may further be defined for example in the form of logical operations between fields and/or their content. The system is operable to also assign specific rewards/penalties (e.g. particular tickets, shares or penalties) to the contribution of content to specific fields.

In one aspect, the records are configured to enable multiple users to contribute information, however, a particular field is normally assigned to one participating user only, to avoid duplication of efforts. However, where a particular field is a multiple choice, one participating user may select one of the options while another participating user may select another option.

Records are best understood as an output of the task manager (20), generated by operation of the task manager (20) or a utility that is part of the task manager (20) or the record generator (30), as shown in FIG. 1.

The record generator enables the assembly of records with the various fields, relationships between them, permissions (defining what participating users can complete what fields), associated incentives/penalties, and other attributes. Records are configured such that attributes may be modified on the fly without affecting the operability of the record as a whole. The system is also configured so that modifications can be made at the same time across several records without affecting the operability of individual records, or records collectively.

For example, if information linked to a particular field has been challenged, the field may be automatically “locked” by the system, as well as any other fields or attributes that depend on that field. The “locking” of the field may prevent additional information from being added to fields that depend on the “locked” field, until the challenge has been resolved. Other fields however may continue to be completed by participating users. Once a “lock” has been removed the corresponding “lock” to other fields or attributes may also be removed.

Also, if a participating user is identified who has been making contributions that do not meet the quality attributes intentionally or with regularity, his or her contributions may be dynamically removed and re-submitted to the crowd via a new invitation, without the need for significant data processing.

This particular aspect of the implementation enables the various dynamic operations involved in both completing tasks and sub-tasks and also the generation and exploitation of products based on completed tasks and sub-tasks and presents a significant innovation.

Another aspect of records is that the records and the database (14) are configured to enable information from the records to be compiled into the database without little effort, in a manner that is known, as shown in FIG. 1. This enables the consumption of information obtained by operation of the present system by third party entities on a real time or near real time basis. In this way, one aspect is a computer network implemented distribution network for distributing information obtained by operation of the platform.

In another aspect of the record generator (30), records are generator so that one or more fields are associated with labels that consist of a code defining the field attributes rather than for example a label expressed in text form. This enables the derivation of information from records independent of the text used in the fields, including for example any particular language used to express labels. Moreover, information provided as content for a field may be recorded to the record as a form element defined by a code rather than the text content. This is easily accomplished where the information elements are selected by users from a menu of possible items, or where the code is defined based on a semantic analysis of contributed text. One of the advantages of generating records in this way is that derivatives of the information may be generated and used dynamically. For example translations of a database may be mapped using one or more simple operations rather than a more complicated translation which may result in errors.

The operation of records, as a function of the task manager (20) is illustrated in the example provided below, which is based on application to location data.

A Place Record is created by applying schema rules to available place data. Data is stored as a set of rows with references to relationships between them and their type (by field id). The schema is the set of all possible fields with corresponding descriptions of their format and dependencies between them. A field is “dependent” when it can appear in a record only if another field is set to appropriate value.

Some possible place fields may be:

| | | POSSIBLE | |
|---|---|---|---|
| FIELD NAME | TYPE | VALUES | DEPENDS ON |
| Place Name | Text | <not empty> | — |
| Place type | Enumeration | Eating, | — |
| | (multiple | sleeping, | |
| | values possible) | medical | |
| Cuisine | Enumeration | American, | PlaceType.eating |
| | (multiple | Greek, | |
| | values possible) | Asian | |
| Dress code | Enumeration | Casual, | PlaceType.eating |
| | (only singe | formal | |
| | value possible) | required | |
| Room Details: | Enumeration | Private | PlaceType.sleeping |
| | (multiple | Patio, | |
| | values possible) | Separate | |
| | | Eating Area | |
| Number of | Numeric | Number | PlaceType.sleeping |
| Rooms | | | |

(i) Loading Place Record

The Place Record is loaded through the following steps:
1) all available data is loaded for the requested place (for each available piece of data the system looks up its field meta data in schema).
2) “independent” pieces of data are picked and these are added to “data set to be displayed”.
3) the rest of the dependent data is scanned, trying to find elements that depend on elements in “data set to be displayed”.
4) if any such elements are found, these are added to “data set to be displayed” and scanned again, when no remaining elements are found, the scanning stops.
5) any data that has been retrieved from the database but not depending on other data is deemed to be “disconnected” because of a previous schema change. Depending on requirements the system may delete disconnected data or just ignore it.

(ii) Displaying Place Record

After the place record is loaded, it is prepared for display through the following steps:
1) the credentials of the participating user who is to view the record is obtained. The fields are scanned, examining them to see whether they should be displayed based on that user's permissions. Fields are filtered out if necessary based on permissions.
2) using the context of display (web, mobile, etc.), fields may be filtered if they are not to be shown in this context.
3) the record generation is repeated to remove unneeded dependencies.
4) based on formatting rules described in the same schema, a representation is generated of the fields according to the form type (text, multi-select, etc.).

(iii) Editing Place Record

To edit the record, the following steps may be performed:
1) when new information arrives, the system looks up its definition in the schema.
2) the system drops those for which no definition is found, or where input format or data don't match to what is described in the schema.
3) the system generates the record as discussed above with the existing data.
4) the system iterates through new data trying to find those elements that are eligible to be stored in the database. To be eligible, the field must be independent, or dependant on existing data, and the field must be unlocked (the system may “lock” data when it is not desirable for users to modify it).
5) the system repeats the iterations until all incoming information has been processed.
6) possibly as result of the modification, some dependent data may get disconnected from the place record.
7) depending on the business logic, the incoming data will either be persisted in the database right away or stored for review (in which case the system may “lock” the field and may not allow other modifications until it's unlocked).

Record Completion Utility

Also as shown in FIG. 1, the system may include a record completion utility (36). The record completion utility (36) is operable to enable participating users to complete tasks or sub-tasks, for example as directed by the task manager (20) including by operation of the records described above. The record completion utility (36) may be implemented as a client computer program that may be loaded on a computer device associated with a participating user. The record completion utility (36) may be implemented for example as a browser plug-in. The record completion utility (36) may consist of a standard browser, which by initiating a communication session with the web server (10) may be operable to load one or more records on the participating user side, such that information is provided by the participating user in one or more communication sessions.

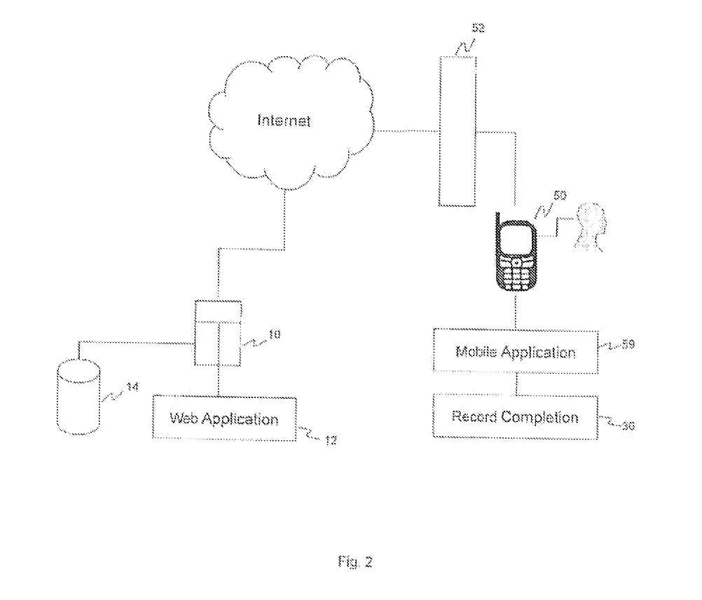

Alternatively, the record completion utility (36) may be linked to, or otherwise connected to, a mobile application (59), as illustrated in FIG. 2. In this embodiment of the present invention, a mobile device (50) may be linked to the web sewer (10) through the internet by way of a connection means (52). In this manner the mobile application linked to, or incorporated with, the mobile device may provide for record completion and updating of information and participating user records on the web server.

Workflow

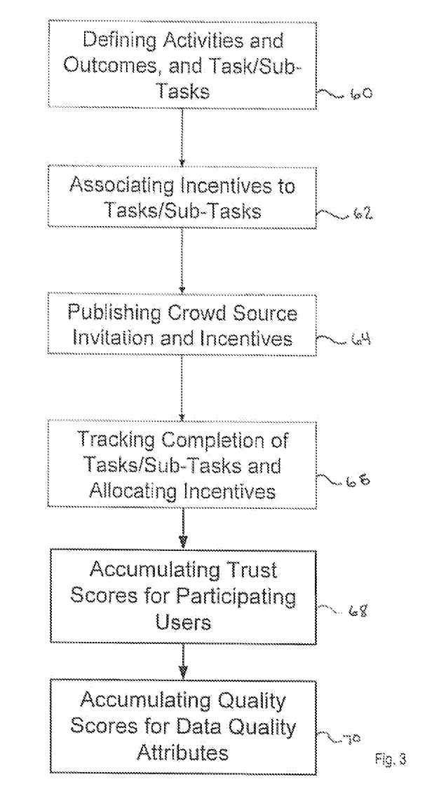

One embodiment of the present invention may be a method for enabling a platform operator, or client of the platform operator, to manage the completion of one or more activities. The one or more activities may include a plurality of tasks, and each task may optionally include a plurality of sub-tasks. The method of such an embodiment of the present invention may include the following steps, as shown in FIG. 3:
(A) a definition step (60) that involves defining one or more activities associated with one or more desired outcomes, and based on the activities and desired outcomes defining one or more tasks or sub-tasks for completion by users responding to an open crowd source invitation (“participating users”);
(B) an association step (62) that involves associating with the tasks or sub-tasks one or more incentives for motivating participating users to complete the tasks or sub-tasks in a manner that is consistent with the desired outcomes;
(C) a publishing step (64) that involves publishing the open crowd source invitation and the associated one or more incentives; and
(D) a tracking step (66) that involves tracking any resulting completion of the tasks or sub-tasks by the participating users and allocating based on such completion the incentives to the relevant participating users.

The method may also include one or more of the following additional steps:
(E) an incentive association step that involves associating incentives that includes rewards and/or shares, and/or penalties associated with the rewards and/or shares; and
(F) a task association step that involves associating with the tasks or sub-tasks one or more gaming elements for enabling gaming-based competition between participating users for incentives.
(G) a trust application step that may involve applying trust through Trust Scores and Quality Scores to support the operations of the platform, as described above, and may incorporate the additional steps of: accumulating Trust Scores for participating users (68) and accumulating Quality Scores for data quality attributes (70).

A skilled reader will recognize that various other methods may result from the operation of the platform, with its various features and utilities, as described in this disclosure. The method shown in FIG. 3 is merely one example of a possible method of an embodiment of the present invention.

Further Aspects of Implementation

The present invention may have several embodiments, as described herein. The following descriptions provide details of possible embodiments of the present invention and implementation of such embodiments. A skilled reader will recognize that several embodiments and implementations of such embodiments are possible, and that the description below merely provides examples of some possible embodiments and implementations thereof.

(i) System Implementations

In one embodiment of the present invention, a system may be implemented using a distributed and networked computing environment comprising at least one computing device. In a particular implementation, at least three sets of computing devices may be provided. Each set of computing devices may comprise one or more computing devices linked by a network. Typically, at least one set of computing devices would generate and send the records over the network to a second set of computing devices. The second set of computing devices receives the records and may provide information, or correct or verify information included in the records. However, it should be understood that the generation, correction, or verification of information, may be processed on any number of computing devices ranging from one computing device to many computing devices.

At least a third set of computing devices may be used to obtain or receive the information, including information in an aggregated form, for further staging, analysis, synthesis, consumption, or other use thereof. The use of the information may be user generated or machine generated.

(ii) Mobile Implementations

In one embodiment of the present invention enhancements may be incorporated in the present invention wherein one or more of the computing devices are mobile devices or wirelessly networked devices. An example of an embodiment of the present invention that may be implemented to incorporate a mobile device is shown in FIG. 2. For example, the network may be, or include, a wireless network, the wireless network including a wireless gateway for linking the wireless network to the Internet. The network-connected devices as previously described may consist of wirelessly networked devices (50) that are operable to access the Internet via a wireless gateway (52). The wirelessly networked devices described may include a browser for interacting with the web server (10) to access functions of the web application (12). Alternatively, the wirelessly networked device (50) may include a mobile application (54), which may include one or more utilities or features providing the record completion function (36) which interoperates with the web server (10) to enable completion of records using the wirelessly networked device (50). The wirelessly networked devices could also be equipped with additional functionality for providing information regarding users that enables the targeting of particular users, including for example a GPS receiver operable to provide GPS location information to invite particular users to complete tasks or sub-tasks or to allocate tasks to particular participating users. The wirelessly networked devices may also include one or more accelerometers or other movement sensors operable to provide movement-based or gesture-based information. Thus, the messaging to be returned to the platform may include location, movement and/or gesture relevant content.

A skilled reader will recognize that the wirelessly networked device as described may consist of a hand-held two-way wireless paging computer, a wirelessly enabled palm-top computer, a mobile telephone with data messaging capabilities, a portable digital media player, or a wirelessly enabled laptop computer, but could be any type of mobile data communication device capable of sending and receiving messages via a network connection. The majority of current mobile communication device users, however, use a mobile telephone with data messaging capabilities, such as server addressing capabilities such as Short Message Service (“SMS”) or Multimedia Messaging Service (“MMS”) or data including GPRS or 3G. The present system and method therefore provides means for providing the functionality described herein, from mobile communication devices that are relatively common and inexpensive.

(ii) Generic Implementation

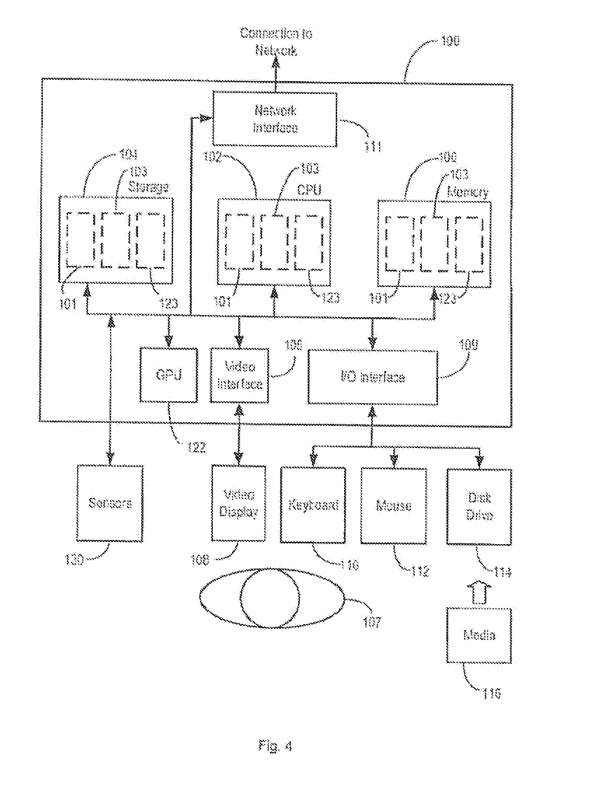

In embodiments of the present invention, a suitably configured computer device, and associated communications networks, devices, software and firmware may provide a platform for enabling one or more embodiments, as described above. An example of an embodiment of the present invention that may be operable for a generic implementation is shown in FIG. 4. A computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 110, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 130 may be used to receive input from various sources.

Embodiments of the present invention may be practiced on virtually any manner of computer device including a desktop computer, laptop computer, tablet computer or wireless handheld. The present system and method may also be implemented as a computer-readable/usable medium that includes computer program code to enable one or more computer devices to implement each of the various process steps in a method in accordance with the present system and method. A skilled reader will recognize that the terms computer-readable medium or computer usable medium comprises one or more of any type of physical embodiment of the program code. In particular, the computer-readable/usable medium can comprise program code embodied on one or more portable storage articles of manufacture (e.g. an optical disc, a magnetic disk, a tape, etc.), on one or more data storage portioned of a computing device, such as memory associated with a computer and/or a storage system.

While the above description provides examples of one or more embodiments of the invention, it will be appreciated that numerous other embodiments may be within the scope of the present invention, as defined by the following claims.

1) A computer network implemented method for accumulation and verification of trust for each of a plurality of participating users engaged in one or more crowd sourcing activities, said method comprising the steps of:
a) inviting the plurality of participating users through an open crowd sourced invitation to complete the one or more the crowd sourcing activities or a portion thereof; and
b) assigning a trust score to each of the plurality of participating users, said trust score being based on completion of the one or more crowd sourcing activities or a portion thereof to indicate a level of trust earned by a participating user relating to the veracity of the completion of the one or more crowd sourcing activities or a portion thereof by each of the plurality of participating users, and said trust score being one of the following: increased if the participating user engages in an activity or behaviour that reflects an increase of trust; and lowered if the participating user engages in an activity or behaviour that reflects a lessening of trust.

2) The method of claim 1, comprising the further step of completing a portion of the one or more crowd sourcing activities that is one or more of the following: one or more tasks incorporated in the one or more activities; and one or more sub-tasks incorporated in the one or more tasks of the one or more activities.

3) The method of claim 1, comprising the further step of verifying the veracity of the completion of the one or more crowd sourcing activities or a portion thereof by each participating user to determine the correctness or accuracy of such completion by each participating user.

4) The method of claim 1, comprising the further steps of:
a) defining the one or more crowd sourcing activities and portions thereof and a desired outcome for each of the one or more crowd sourcing activities and portions thereof; and
b) assigning a trust score to each of the plurality of participating users based on the completion of the one or more crowd sourcing activities so that the trust score reflects completion in accordance with the desired outcome of each of the one or more crowed sourcing activities or portions thereof, whereby the activity or behaviour of each of the plurality of participating users in the completion: increases trust if such activity or behaviour reflects completion in accordance with the desired outcome; and decreases trust if such activity or behaviour reflects completion that is not in accordance with the desired outcome.

5) The method of claim 1, comprising the further steps of:
a) associating one or more incentives to each of the one or more crowd sourcing activities and any portion thereof;
b) assigning a trust score to each of the plurality of participating users that incorporates one or more of the following incentives: rewards; shares; and penalties; and
c) providing one or more tangible incentives to one or more of the plurality of participating users based on the assigned trust scores.

6) The method of claim 1, comprising the further step of assigning a quality score to each of the plurality of participating users, said quality score being based on completion of the one or more crowd sourcing activities or a portion thereof to indicate quality attributes relating to the completion of the one or more crowd sourcing activities or a portion thereof by each of the plurality of participating users.

7) The method of claim 1, comprising the further step of publishing the one or more crowd sourcing activities and one or more incentives relating to the one or more crowd sourcing activities or a portion thereof, whereby the one or more crowd sourcing activities and the one or more incentives related thereto are accessible by one or more users.

8) The method of claim 1, comprising the further step of tracking completion of the one or more crowd sourcing activities and any portion thereof by each of the plurality of participating users and allocating trust scores to each of the plurality of participating users in relation to said completion.

9) The method of claim 1, comprising the further step of creating a record for each of the plurality of participating users, and storing the assigned trust scores in said record.

10) A computer network implemented system for accumulation and verification of trust for each of a plurality of participating users engaged in one or more crowd sourcing activities, said system comprising:
a) a server linked to an application, said server being operable to implement the application so that said application is accessible and operable by: an operator; and each of the plurality of participating users, whereby said plurality of participating users engage in the one or more crowd sourcing activities or any portion thereof; and
b) an administrative utility incorporated in the application and operable to implement the one or more crowd sourcing activities or any portion thereof for completion by each of the plurality of participating users and to assign one or more trust scores based on said completion to each of the plurality of participating, said one or more trust scores being based on completion of the one or more crowd sourcing activities or a portion thereof to indicate a level of trust earned by a participating user relating to the veracity of the completion of the one or more crowd sourcing activities or a portion thereof by each of the plurality of participating users, and said trust score being one of the following: increased if the if the participating user engages in an activity or behaviour that reflects an increase of trust; and lowered if the participating user engages in an activity or behaviour that reflects a lessening of trust.

11) The system for of claim 10, wherein the application is operable to generate a record for each of the plurality of participating users, and said record and data related thereto, including the one or more trust scores, is storable on a database linked to said application.

12) The system of claim 10, wherein an event tracker means is incorporated in the application, said event tracker means being operable to: facilitate the design of the one or more crowd sourcing activities by an operator utilizing a task manager incorporated in the event tracker means; and track the engagement of each of the plurality of participating users with the one or more crowd sourcing activities and portions thereof.

13) The system of claim 10, wherein an incentive manager utility is incorporated in the application, said incentive manager utility being operable to accumulate the trust scores in relation to the completion of the one or more crowd sourcing activities by each of the plurality of participating users and to assign said trust scores to each of the plurality of participating users.

14) The system of claim 13, wherein the incentive manager is further operable by an operator to associate one or more incentives with each of the one or more crowd sourcing activities and portions thereof by allowing the operator to:
a) select the one or more incentives from a range of types of incentives, including at least the following: rewards; and shares;
b) assign a value to each of the one or more incentives;
c) select one or more penalties to be associated with any of the one or more incentives; and
d) assign a value to each of the one or more penalties.

15) The system of claim 14, wherein the application is operable to:
a) assign the trust scores to incorporate the one or more incentives and the one or more penalties; and
b) provide tangible incentives to each of the plurality of participating users based on the trust scores.

16) The system of claim 10, wherein the application incorporates one or more gaming elements, whereby the accuracy of the completion of the one or more crowd sourcing activities and portions thereof are improved.

17) The system of claim 10, wherein a mobile device is utilized by at least one of the plurality of participating users to engage the application and to thereby complete at least one of the one or more crowd sourcing activities or a portion thereof.

18) The system of claim 10, wherein the application incorporates an analytics engine operable to analyze a plurality of operations of the application including any of the following: metric related to the completion of the one or more crowd sourcing activities or portions thereof; demographics of at least one of the plurality of participating users; rate of completion of the one or more crowd sourcing activities or portions thereof; accuracy and correctness of completion of the one or more crowd sourcing activities and portions thereof; and projected time for completion of at least one of the one or more crowd sourcing activities or portions thereof.

19) The system of claim 10, wherein the application is operable to:
a) enable each of the plurality of participating users to verify the completion and content of any of the one or more crowd sourcing activities completed by another of the plurality of participating users; and
b) assign trust scores to each of the plurality of participating users that verify the completion or content of any of the one or more crowd sourcing activities.

20) The system of claim 10, wherein the application is operable to generate and assign the trust scores to incorporate a quality score relating to each of the plurality of participating users, said quality score being based on completion of the one or more crowd sourcing activities or a portion thereof to indicate quality attributes relating to the completion of the one or more crowd sourcing activities or a portion thereof by each of the plurality of participating users.
